(19) United States
(12) Patent Application Publication
(10) Pub. No.: US 2010/0214349 A1
(43) Pub. Date: Aug. 26, 2010

(54) CLOTH PRODUCT PRINTING SYSTEM

(75) Inventor: Chizuo Ozawa, Nagano (JP)

Correspondence Address: BUCHANAN, INGERSOLL & ROONEY PC, POST OFFICE BOX 1404, ALEXANDRIA, VA, 22313-1404, US

(73) Assignee: MASTERMIND CO., LTD, Shiojiri-shi (JP)

(21) Appl. No.: 12/600,029

(22) PCT Filed: May 9, 2008
(86) PCT No.: PCT/JP2008/001174

§ 371 Date: Nov. 13, 2009

(30) Foreign Application Priority Data
May 14, 2007 (JP) 2007-128092

(51) Int. Cl. B41J 2/015

(52) U.S. Cl. 347/20

(57) ABSTRACT

A printing system for T-shirts applies a surface-treatment agent to a printing area of the surface of T-shirts set on a printing bed, by using a surface-treatment ink jet printer equipped with a spray nozzle of a valve-jet type. Next, white ink is applied to the printing area by an ink jet printer for the white ink, and a color image is then printed on the printing area by a color ink jet printer. The cloth-product printing operation needing the surface treatment can be efficiently performed by applying a surface treatment agent onto only the portion needing it with use of the spray nozzle of the valve-jet type.

### TECHNICAL FIELD

The present invention relates to a cloth product printing system for directly printing a color image onto a T-shirt or another cloth product using an inkjet printer.

### BACKGROUND ART

An inkjet printer can be used for printing on various materials. For example, an inkjet printer and a print method for printing directly on a T-shirt are proposed in Patent Document 1. In the disclosed method, a T-shirt is mounted on a platen that is somewhat smaller than the T-shirt, the portion of the T-shirt that hangs down from the periphery of the platen is folded under the platen, and in this state, an inkjet head prints on the portion of the T-shirt mounted on the platen.

[Patent Document 1] U.S. Pat. No. 6,095,628

In the case that printing is carried out directly on a T-shirt or another cloth product using an inkjet printer, steps are generally carried out in which a surface-treatment agent is applied, printing is carried out on the surface-treatment agent, and the printed matter is thereafter heat dried. In the step for applying a surface-treatment agent, the surface-treatment agent is manually applied on the entire cloth product using a spray gun. In the case of a cloth product having a dark ground color, a white ink is applied after the step for applying a surface-treatment agent to form a white foundation, and a color image is printed on the white foundation, whereby color reproducibility is assured.

### DISCLOSURE OF THE INVENTION

An object of the present invention is to provide a cloth product printing system in which a color image can be printed with good efficiency on a cloth product that requires surface treatment without using a manual procedure.

In order to achieve the object described above, the cloth product printing system of the present invention is characterized in comprising:

a surface-treatment inkjet printer for applying a surface-treatment agent on a surface of a cloth product; and

a color inkjet printer for printing a color image in a print surface region of the cloth product to which a surface-treatment agent has been applied, wherein

the surface-treatment inkjet printer is an inkjet printer of a valve-jet type having spray nozzles of a valve-jet type, a compressor for feeding the surface-treatment agent to the spray nozzles, and an electromagnetic on-off valve for switching the spray nozzles on and off.

In the present invention, an inkjet printer of a valve-jet type is used as the surface-treatment inkjet printer. The amount of surface-treatment agent to be applied is much greater than the amount of ink to be applied by a common inkjet printer. The surface-treatment agent must be repeatedly discharged in the same area in order to apply the surface-treatment agent using an ordinary inkjet printer, a large amount of time is required, and actual application is difficult. The step for applying the surface-treatment agent can be automated without the use of manual labor by using an inkjet printer of a valve-jet type.

In this case, it is preferred that print area specifying means for specifying the print area of the cloth product be provided, and that the surface-treatment agent applied by the surface-treatment inkjet printer be applied only to the print area.

Accordingly, the effect of the surface-treatment agent on the cloth can be reduced without wasteful use of the surface-treatment agent.

There is preferably provided a white-ink inkjet printer for applying white ink onto the surface of a cloth product to which the surface-treatment agent has been applied. A color image can be printed without affecting the ground color of the cloth product by applying white ink and making the foundation white.

In the present invention, a surface-treatment agent is applied onto the surface of the cloth product using an inkjet printer of a valve-jet type, and the surface treatment is carried out for color printing. Therefore, it is possible to obtain a printing system for printing any color image with good efficiency on the surface of a T-shirt or another cloth product without using a manual procedure.

### BRIEF DESCRIPTION OF THE DRAWINGS

FIG. 1 is a view of the overall configuration of the printing system to which the present invention has been applied; and

FIG. 2 is a schematic view of an inkjet printer of a valve-jet type used as the surface-treatment inkjet printer of FIG. 1.

### BEST MODE FOR CARRYING OUT THE INVENTION

An embodiment of a T-shirt printing system to which the present invention has been applied is described below with reference to the drawings.

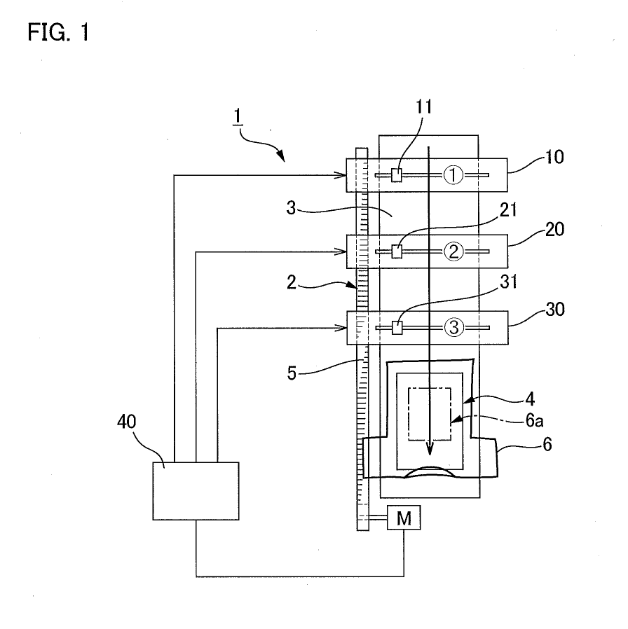

FIG. 1 is a view of the overall configuration of the T-shirt printing system in which the present invention has been applied. The T-shirt printing system 1 has a conveyance unit 2, and a conveyor mechanism 5 for conveying a flat rectangular parallelepiped printing bed 4 in the longitudinal direction is provided to a conveyance surface 3 that extends in the longitudinal direction of the conveyance unit 2. A surface-treatment inkjet printer 10, a white-ink inkjet printer 20, and a color inkjet printer 30 are arranged at fixed intervals from the front side to the rear side above the conveyance surface 3.

The surface-treatment inkjet printer 10 moves a spray nozzle 11 in a reciprocating fashion in a direction orthogonal to the conveyance direction of the printing bed 4, and applies a surface-treatment agent on a print area 6a on the surface of a T-shirt 6 mounted on the printing bed 4 which passes directly under the spray nozzle 11. The white-ink inkjet printer 20 also moves an inkjet head 21 in a reciprocating fashion in the direction orthogonal to the conveyance direction of the printing bed 4, and applies white ink on a print area 6a on the surface of a T-shirt 6 mounted on the printing bed 4 which passes directly under the inkjet head 21. The color inkjet printer 30 also moves an inkjet head 31 in a reciprocating fashion in the direction orthogonal to the conveyance direction of the printing bed 4, and prints a color image on a print area 6a on the surface of a T-shirt 6 mounted on the printing bed 4 which passes directly under the inkjet head 31.

The conveyor mechanism 5, the surface-treatment inkjet printer 10, the white-ink inkjet printer 20, and the color inkjet printer 30 are drivably controlled by a print control device 40 composed mainly of a computer. The print control device 40 specifies the print area 6a to be printed by the color inkjet printer 30, and drivably controls the surface-treatment inkjet printer 10 and the white-ink inkjet printer 20 so that the surface-treatment agent and the white ink are applied on the print area 6a.

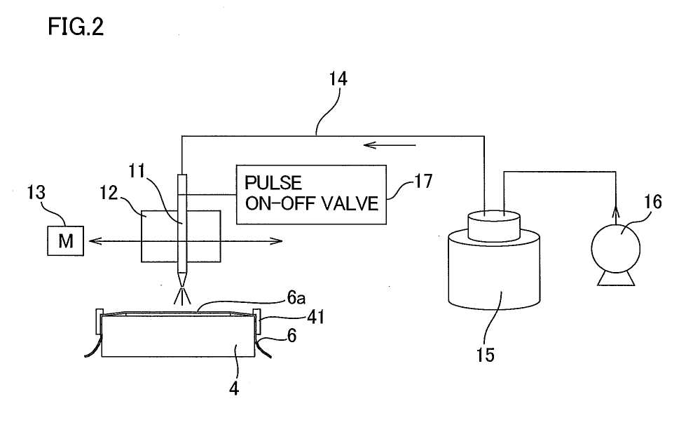

FIG. 2 is a conceptual view of an inkjet printer of a valve-jet type used as the surface-treatment inkjet printer 10. The surface-treatment inkjet printer 10 is provided with a spray nozzle 11 of a valve-jet type as a print head, and the spray nozzle 11 is mounted on a head carriage 12, which is moved in a reciprocating fashion by a carriage motor 13 along the direction orthogonal to the conveyance direction of the printing bed 4. A surface-treatment agent is fed from a surface-treatment agent tank 15 to the spray nozzle 11 via a surface-treatment agent feed tube 14. The surface-treatment agent is fed by a compressor 16. A pulse-driven electromagnetic on-off valve 17 is mounted on the spray nozzle 11, the electromagnetic on-off valve 17 is opened and closed under the control of the print control device 40, and surface-treatment agent is applied onto the print area 6a.

The operation for printing on the T-shirt 6 will be described using the printing system 1 of the present example. First, a T-shirt 6 is placed on the printing bed 4 and stretched so as to form a flat surface, and in this state a frame plate 41 is mounted from above and set with the T-shirt 6 in a stretched state.

The printing bed 4 on which the T-shirt 6 has been set is conveyed by the conveyor mechanism 5 through the printing position of the surface-treatment inkjet printer 10. The surface-treatment agent is applied onto the print area 6a on the surface of the T-shirt 6 as [the T-shirt 6] passes through the printing position of the surface-treatment inkjet printer 10. The T-shirt 6 on the printing bed 4 is thereafter conveyed through the printing position of the white-ink inkjet printer 20, and white ink is applied onto the print area on which the surface-treatment agent has been applied. Next, the T-shirt 6 on the printing bed 4 is conveyed through the printing position of the color inkjet printer 30, and a color image is printed on the print area.

When printed is completed, the T-shirt 6 is removed from the printing bed 4 and processed by heat (hot press or hot-air drying) to fix the printed surface in place.

1. A cloth product printing system, comprising:
a surface-treatment inkjet printer for applying a surface-treatment agent to a surface of a cloth product; and
a color inkjet printer for printing a color image on the surface of the cloth product to which the surface-treatment agent has been applied, wherein
the surface-treatment inkjet printer comprises an inkjet printer of a valve-jet type having valve-jet nozzles, a compressor for feeding the surface-treatment agent to the valve-jet nozzles, and an electromagnetic on-off valve for switching the valve-jet nozzles on and off.

2. The cloth product printing system according to claim 1, comprising print area specifying means for specifying a print area of a color image on the surface of the cloth product, wherein the surface-treatment inkjet printer applies the surface-treatment agent only to the print area.

3. The cloth product printing system according to claim 1, comprising a white-ink inkjet printer for applying white ink to the surface of a cloth product to which a surface-treatment agent has been applied, wherein the color inkjet printer prints a color image onto the surface of the cloth product to which white ink has been applied.

4. The cloth product printing system according to claim 2, comprising a white-ink inkjet printer for applying white ink to the surface of a cloth product to which a surface-treatment agent has been applied, wherein the color inkjet printer prints a color image onto the surface of the cloth product to which white ink has been applied.
